(19) United States
(12) Patent Application Publication
(10) Pub. No.: US 2006/0004797 A1
(43) Pub. Date: Jan. 5, 2006

(54) Geographical location indexing

(75) Inventors: Soren Riise, Ruislip (GB); Devesh Patel, Ruislip (GB); Bruce Andrew Campbell, Potters Bar (GB)

Correspondence Address: IPSOLON LLP, 805 SW BROADWAY, #2740, PORTLAND, OR, 97205, US

(73) Assignee: Whereonearth Ltd

(21) Appl. No.: 10/982,629

(22) Filed: Nov. 4, 2004

(30) Foreign Application Priority Data
Jul. 5, 2004 (GB) 0415072.8

(51) Int. Cl. G06F 17/00

(52) U.S. Cl. 707/100

(57) ABSTRACT

A geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone.

### TECHNICAL FIELD

This invention relates to a method of indexing data relating to geographical locations and a geographical location index produced by the method.

### BACKGROUND

Indexing geographical location data which has a spatial component is becoming increasingly difficult as data volumes are increasing in size and service providers such as search engines and the like are attempting to organize geographical data for fast retrieval. For many applications dealing with geographical data, such as, but not limited to, “local” searches through the World Wide Web, the most important function is to query data concerning a given geographical point and then to return data ordered by its proximity to the given geographical point, starting with the data nearest to the given geographical point.

A number of spatial indexing technologies allow the querying of objects within a bounded rectangle or circle and will return all data within the requested area. Problems occur when the bounded area is too small and consequently too little (or no) data is retrieved. On the other hand, if the bounded area is too large, then too much data is retrieved. In the first case, the application has to extend the search area to find some or more relevant data and in the second case the volume of data is too great to be efficiently processed either by the application or the user. This means that the scalability in retrieving data is compromised.

There are algorithms that attempt to address this problem from a purely mathematical perspective but these are not discussed further.

### SUMMARY OF THE INVENTION

The present invention seeks to provide an alternative method for spatial indexing of geographical data to allow results proximal to a target geographical location, i.e. determining from the target geographical location one or more nearby geographical locations or data concerning the nearby geographical locations. This allows the geographical data relating to the target geographical location or nearby geographical locations to be returned more easily. The method differs from traditional spatial indexing by making use of predefined geography (either real or artificial) to create data which can be used for indexing using standard (non-spatial) indexing technology. Hence, the method of the invention allows ready scaling of search results in a manner consistent with normal non-spatial indexing. The method of the invention can also be viewed as offering search results of increased relevance at a local level since it provides improvements in ranking based either on locating names or on geographical hierarchical information.

One aspect of the present invention provides a geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone.

Preferably, each zone has a finite number of neighboring zones in the same layer.

Conveniently, each layer defines a different set of zones.

Advantageously, the zones in one layer represent a predetermined geographical area.

Preferably, the predefined geographical area in one layer is a country, in another layer is a state, in another layer is a county, in another layer is a postcode/zip code and in another layer is a building.

Conveniently, there is a hierarchy of layers having respective zones of diminishing area so that a top layer provides low resolution division of the geographical area a bottom layer provides high resolution division of the geographical area.

Advantageously, for a particular layer, a record of a subject zone contains a zone identifier for the subject zone, the zone identifiers of zones neighboring the subject zone, the or each zone identifier of a zone in another layer containing the subject zone and the zone identifiers of all zones contained within the subject zone.

Preferably, the zones of one layer do not overlap any other zones of the same layer.

Conveniently, a zone of one layer overlaps one or more zones of another layer.

Advantageously, the associated geographical co-ordinates comprise the longitude and latitude or x,y co-ordinates of at least one geographical location in a subject zone.

Preferably, each zone is a polygonal area.

Another aspect of the invention provides a database incorporating an index embodying the invention.

A further aspect of the present invention provides a method of indexing data relating to geographical locations comprising: providing a plurality of layers of geographical information concerning a geographical area, each layer comprising a division of the geographical area into a plurality of discrete zones, each of which has a zone identifier and associated geographical co-ordinates each of which co-ordinates defines a geographical location; and associating for each layer a geographical location with those zones containing the geographical location such that a geographical hierarchy is provided for each geographical location.

Another aspect provides a method of utilizing a geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone, the method comprising searching the index for a target geographical location and determining therefrom one or more nearby geographical locations or data concerning the nearby geographical locations.

### BRIEF DESCRIPTION OF THE DRAWINGS

In order that the present invention may be more readily understood, embodiments thereof will now be described, by way of example, with reference to the accompanying drawings, in which:

FIG. 1 is a schematic view of a top layer low resolution division of a geographical area in accordance with an embodiment of the present invention;

FIG. 2 is a schematic view of a layer below the top layer of FIG. 1 which provides a higher resolution division of the geographical area;

FIG. 3 is a schematic view of a layer below the layer of FIG. 2 which provides a higher resolution division of the geographical area;

FIG. 4 is a schematic view of a layer below the layer of FIG. 3 which provides a higher resolution division of the geographical area;

FIG. 5a-d show a set of tables containing information relating to FIGS. 1-4; and

FIG. 6 shows a flow diagram of a method embodying the present invention.

### DETAILED DESCRIPTION

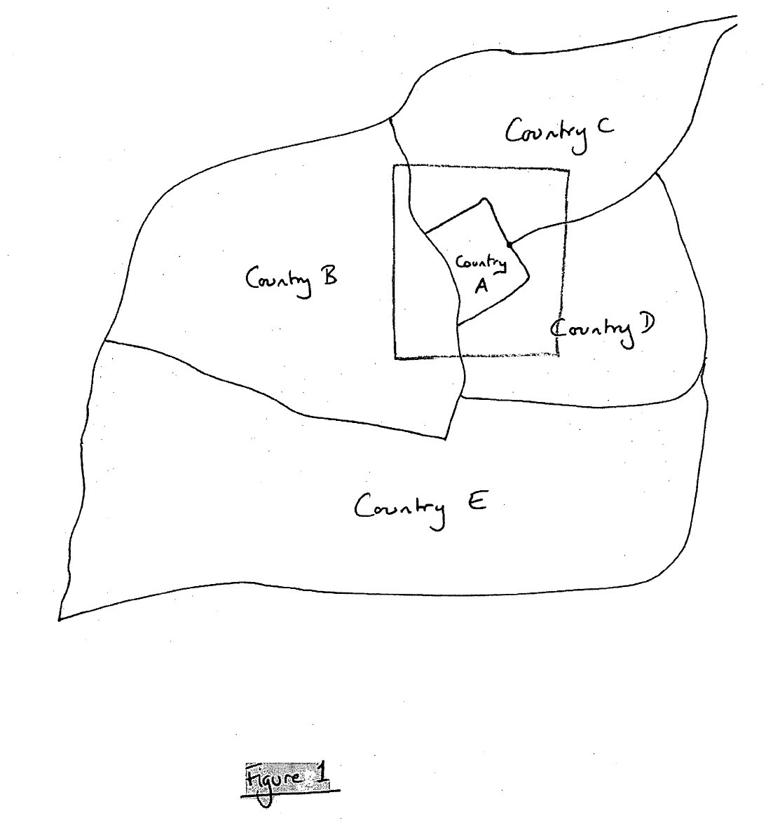

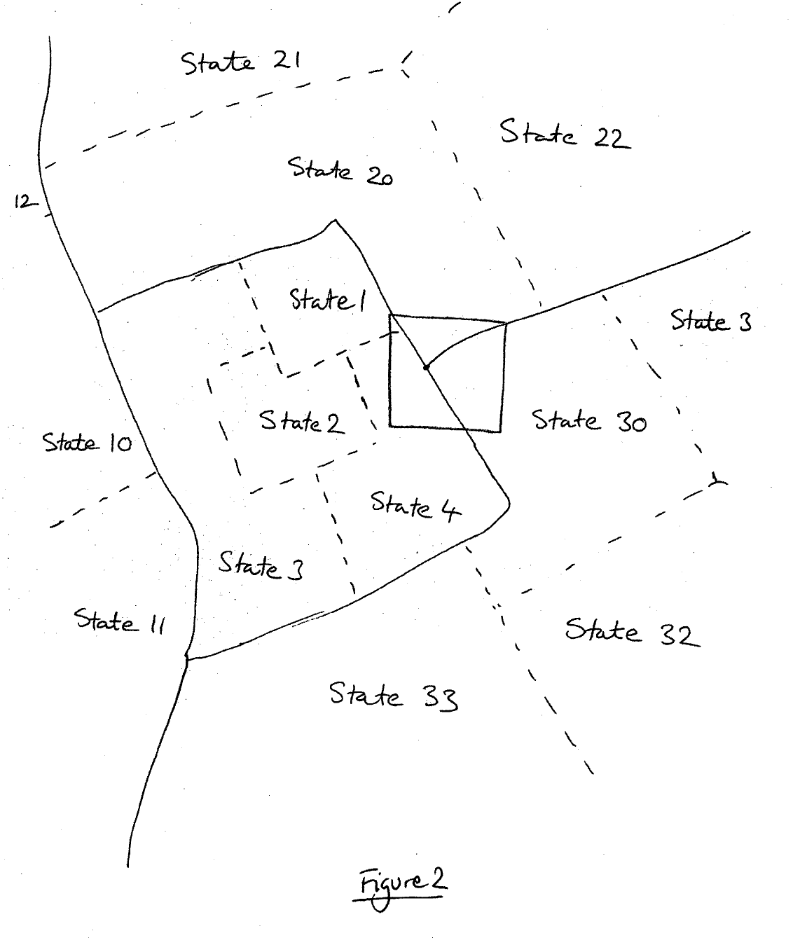

Referring to FIG. 1, a geographical area is divided into a system of discrete non-overlapping geographical zones. Each zone contains a plurality of geographical locations characterized by their geographical co-ordinates. Data relating to each of the geographical locations may be associated with each of the geographical locations.

Each zone is described as a polygon with an associated name (such as a country name in the case of FIG. 1) or identifier. In FIG. 1, the zones are described by their country names, Country1, Country2, etc. Preferably, each zone identifier is based on either a real world name but artificially generated names (such as sequential unique numbers) can also be used. The uniqueness of the identifier is only important for the efficiency of the system.

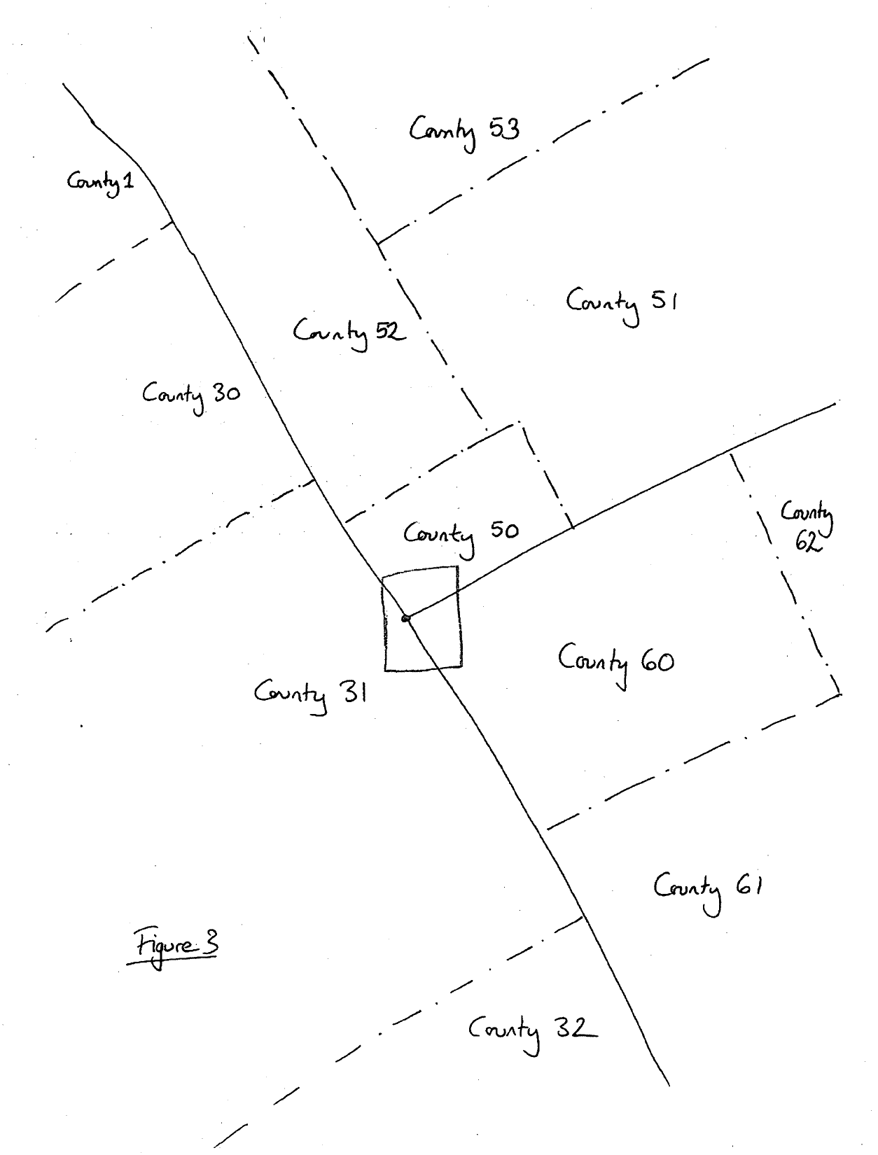

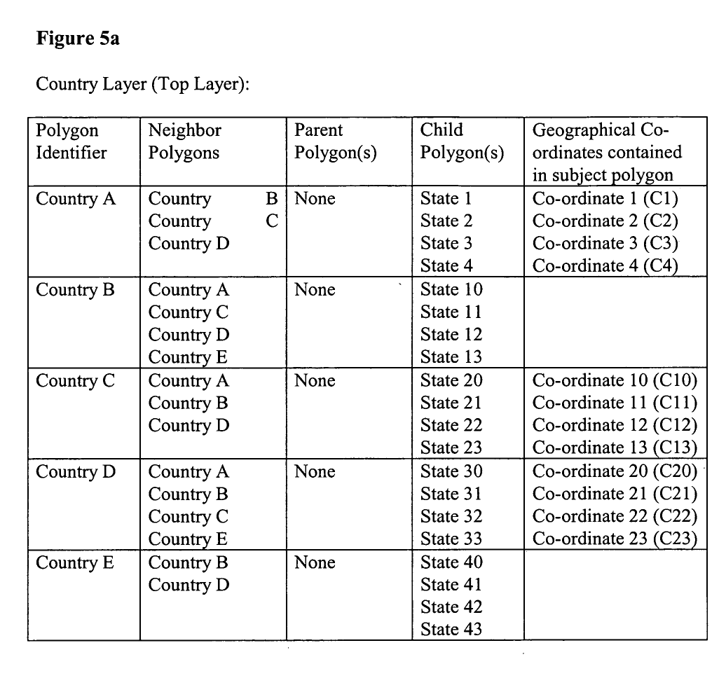

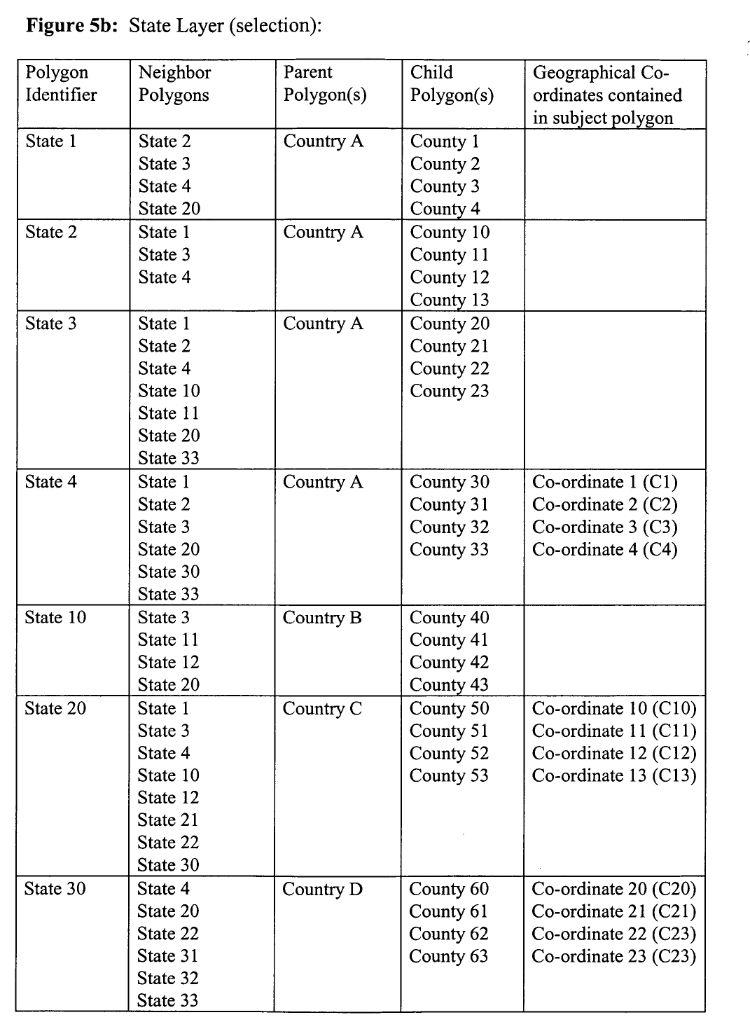

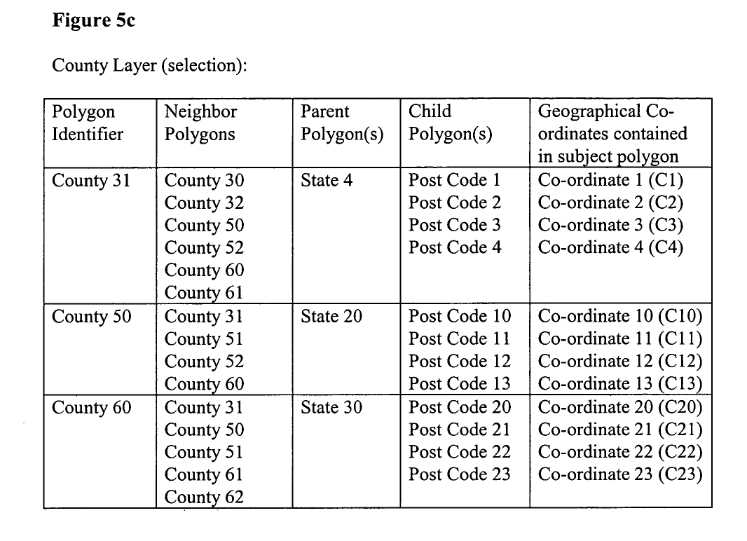

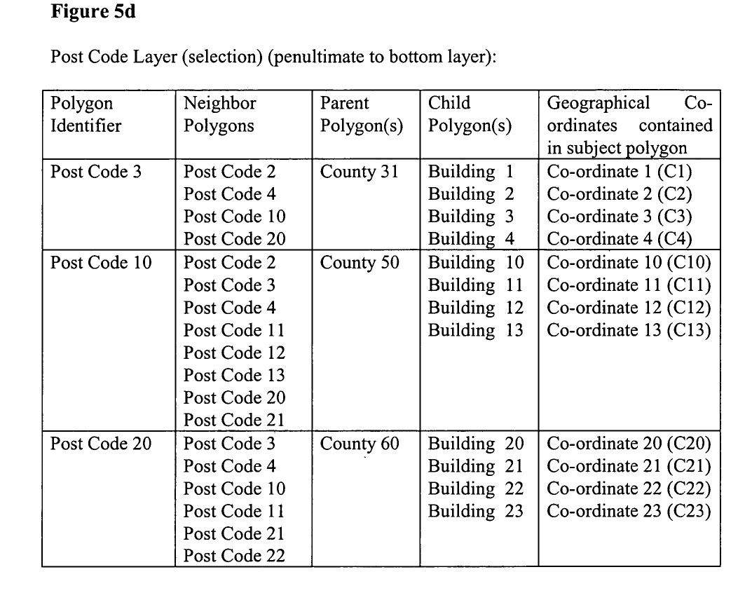

It is possible to form a finite list of the zones in a geographical area by listing all zones by their identification (e.g. in the case of FIG. 1, there is a finite list of countries). That list is shown in the first column of FIG. 5a. Since the zones do not overlap, each zone has a finite number of neighboring zones of the same class, i.e. with the same level of resolution. Each level of resolution is considered as a layer. In the present example, the level of resolution is at a country level: a top layer. Below the top layer, the geographical area is divided into a system of discrete non-overlapping geographical zones of higher resolution than the previous top layer (country layer). In this example, the next layer down from the country level is a state level as depicted in FIG. 2. Each of the state zones also contains a plurality of geographical locations characterized by their geographical co-ordinates. Data relating to each of the geographical locations may be associated with each of the geographical locations. The geographical locations are the same geographical locations as in the country level—i.e. if the geographical location is Chicago, then that location is in USA as a country and Illinois as a state—so the same geographical location is in USA and Illinois.

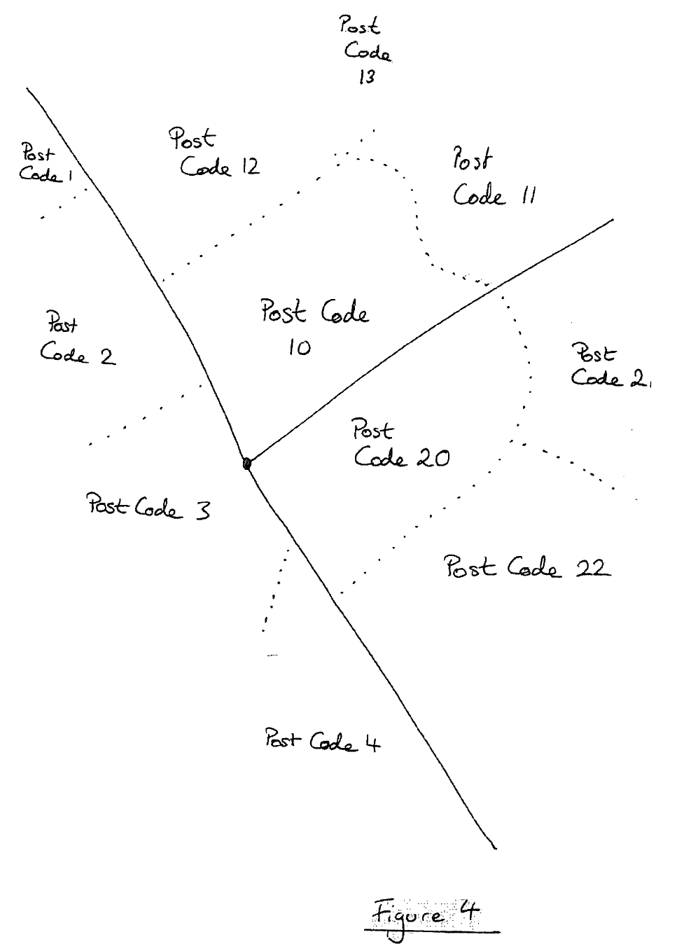

Referring to FIGS. 3 and 4, these depict further layers of the geographical area: FIG. 3 at a County resolution level and FIG. 4 at a Post or Zip Code resolution level.

Additionally, each zone contains a finite number of zones in the layer below. Thus, if the country is the USA, then that country contains all the states of the USA. Each of the zones “contained” in the top layer zones is listed under the respective top layer zone in which they are located. The “contained” zones can be regarded as “child” zones. For the top layer, whilst having “child zones”, there are no zones which “contain” the top zone—“parent” zones. However, lower zones will have “child” zones and one or more “parent” zones. Conversely, the bottom layer will not have any “child” zones but will only have one or more “parent” zones.

Thus, the index for a particular layer comprises a record of the subject zone identifiers in the layer, the zone identifiers of zones neighboring each subject zone, the or each zone identifier of a “parent” zone and the or each zone identifier of all “child” zones.

By combining this information, the index is compiled to produce a list of all geographical areas, their adjoining neighbors, “parent” areas and contained “child” areas. This information is represented in the combination of the tables for each of the layers in FIGS. 5a-d and is preferably embodied in any suitable conventional computer-readable media for utilization by, for example, a search engine, as described below. FIG. 4 illustrates some example co-ordinates within the “postcode” zones. These co-ordinates and the zones which contain them are listed in FIGS. 5a-d. It will of course be appreciated that all of the surrounding postcode zones may also include further co-ordinates, but these are not shown. It will be appreciated from FIGS. 1-4 and the information recorded in the tables of FIGS. 5a-d that co-ordinates C1-C4 are contained in area “Post Code 3”, but also: County 3; State 4; and Country A.

Utilizing this system allows a query for data concerning a given geographical point to be analyzed and to return data ordered by its proximity to the given geographical point—in the first instance data would be returned for the subject zone and then data concerning neighboring zones in the same layer.

The process is repeated for each layer in a geographical system where there are multiple layers of information. So “countries” are processed separately from “states” which are processed separately from “counties” which are processed separately from “postcodes”. As each layer of information is processed separately, it is of no importance if the edge polygons in one layer share edges with another level. (Postcodes can typically cross borders of counties in some countries such as in the UK).

Given a point (x,y) or (longitude, latitude) and given a set of named polygons describing the geographical structure, it is possible to determine to which named geographical identifier a point belongs by checking which polygons it falls within, and hence derive all the neighboring polygons as well.

This invention can be viewed, but not limited to, as a method of increasing relevancy for search engines when doing local searching, by allowing improvements in ranking either based on locality names or geographical hierarchical information.

In one example, the invention is used to index pages from the World Wide Web. A World Wide Web page which mentions “Eiffel Tower” but not “Paris” or “France” can, through this invention, still be indexed using the keywords “Paris” and “France” since the hierarchical structure inherent in the invention contains this information—France and Paris being the parent zones of“Eiffel Tower”.

A world wide web search engine can also use this information to improve the internal page ranking for pages which are known to consistently use the hierarchical information. Thus a page which mentions corresponding locations in different layers (example “Eiffel Tower” and “Paris”) can be given improved ranking for correct use of both terms. Using the hierarchical information in this matter can prove beneficial in countering the practice of “web spamming” where authors of commercial WebPages attempt to gain higher search engine ranking by including long lists of location names.

For example, a web page author will, of course, wish for as many people to visit the web page as possible, so as to increase the number of potential customers for the products and/or services advertised thereon. Should an Internet user wish to locate a web page with particular information, it is common to use the services of an Internet search engine. The user inserts a search term and the search engine then scans the available pages on the Internet to find pages containing the search term, then returns details of these pages to the user. There are, of course, certain search terms that are used very often in Internet searching, for example: “News” or “MP3”. The authors of some web pages—which web pages are not necessarily related to “News” or “MP3”—may wish to improve the likelihood of the web page being returned in a search and will include a list of these common search terms on the web page. Commonly, such web pages will “hide” these terms by using a white colored font on a white background, so that the user is unaware of their existence on the web page.

The invention also, therefore encompasses an analysis whereby the content of a body of information such as a web page or the like is reviewed to determine whether the locations named on the page fall consistently into neighboring zones, child zones or parent zones. If the determination indicates consistent inclusion, then the page ranking can be approved or possibly improved. If the determination indicates that the page contains random locations not linked to a coherent set (predetermined by the analysis criteria) of zones, then the page ranking can be lowered.

Indexing and search of data can now follow any of the following methods:

Method 1:
Any geographical information inserted into the index is recorded against the identifier of each layer of the geographical area it falls within.
Any lookup will search data using the identifier's of each layer of the geographical area and their immediate neighbors of the geographical area. (see FIG. 2).

Method 2:
Any geographical information inserted into the index is recorded against the identifier of each layer of the geographical area and their immediate neighbors it falls within (see FIG. 2).
Any lookup will search data using the identifiers of each layer of the geographical area.

Coding all spatial data to an identifier means that the spatial search is now reduced to traditional keyed indexing technology. This would be carried out using the following method.

Method 3:

In order to satisfy a query for specific data in the vicinity of a target geographical location, the following steps would apply.
Establish the target zone containing the target geographical location.
Use the structures outlined above to find data fulfilling the query within the target zone.
Use the structures outlined above to find data fulfilling the query within zones “neighboring” the target zone. Extend this to include “neighbors of neighbors”.
Use the structures outlined above to find data fulfilling the query within zones containing the target zone—“parent zones”.
Work outwards and upwards, building up a result set that is grouped by zones that are progressively “less local” to the target geographical location.
To aid efficient data retrieval, the index outlined above would be pre-processed to include “maximum efficient search order” information. This would describe the maximum “depth” of neighboring zones to explore before it is more efficient to look for data in a wider “containing zone.”
To further aid efficient retrieval, the geographic data structures outlined above could be attributed with the identifiers of their “neighbors” on the basis of “travel time”, or other measures based on specific variables. In general, the method would enable such variables to be taken into account when “zone neighbors” are identified.

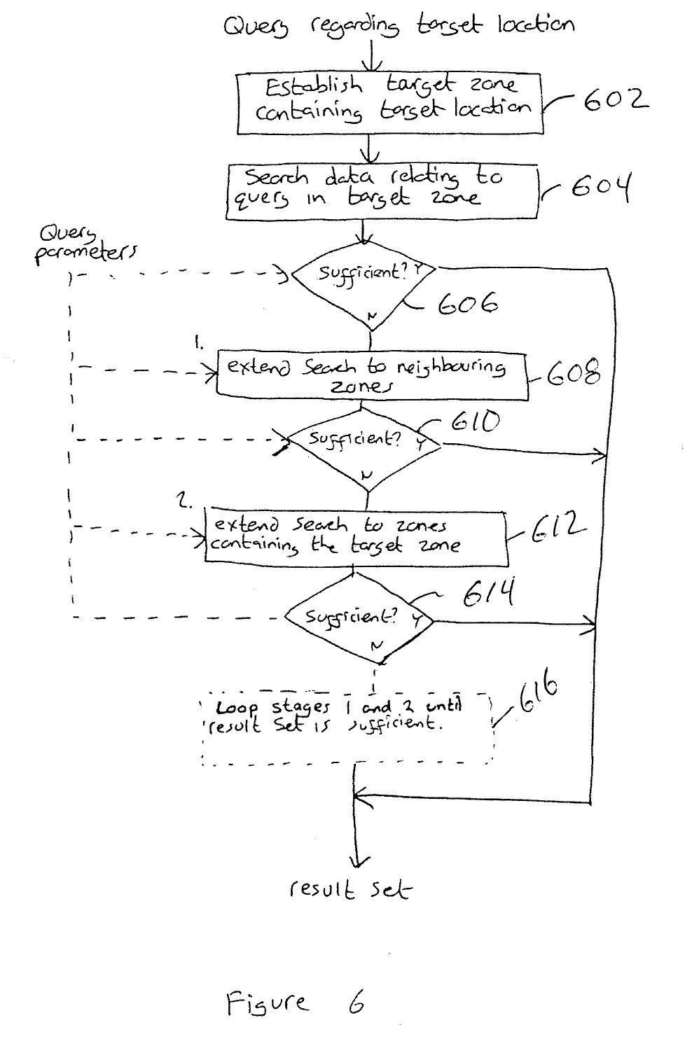

FIG. 6, shows a flow diagram illustrating the steps of method 3. As can be seen from the flow diagram, a query regarding a target geographical location is entered and the target zone containing said target geographical location is established (Step 602). Data relating to the query in that target zone is then searched (Step 604). Following this step, the amount of data returned is analyzed, based on pre-determined query parameters, to see if the level of information is sufficient. If the data is not sufficient, then the area in which the query is being searched is increased to include zones neighboring the originally indicated target zone (Steps 606, 608, 610, 612, 614, 616).

Still further, to aid efficient data retrieval, the index can store other information in relation to a set of given zones. For example, as well as recording a list of neighbors, parents and children of any given zone, other information, such as the time it takes to travel between zones can be recorded. For example, a user could use an index embodying the present invention to query all of the churches within a two hour drive of a target geographical location (e.g. their home).

Still further, to aid efficient data retrieval, the index can store other information in relation to a set of given zones. For example, as well as recording a list of neighbors, parents and children of any given zone, other information, such as the time it takes to travel between zones can be recorded. For example, a user could use an index embodying the present invention to query all of the churches within a two hour drive of a target geographical location (e.g. their home).

1. A computer-readable medium having stored thereon a geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone.

2. An index according to claim 1, wherein each zone has a finite number of neighboring zones in the same layer.

3. An index according to claim 1, wherein each layer defines a different set of zones.

4. An index according to claim 3, wherein the zones in one layer represent a predetermined geographical area.

5. An index according to claim 4, wherein the predefined geographical area in one layer is a country, in another layer is a state, in another layer is a county, in another layer is a postcode/zip code and in another layer is a building.

6. An index according to claim 5, wherein there is a hierarchy of layers having respective zones of diminishing area so that a top layer provides low resolution division of the geographical area a bottom layer provides high resolution division of the geographical area.

7. An index according to claim 1, wherein for a particular layer, a record of a subject zone contains a zone identifier for the subject zone, the zone identifiers of zones neighboring the subject zone, the or each zone identifier of a zone in another layer containing the subject zone and the zone identifiers of all zones contained within the subject zone.

8. An index according to claim 1, wherein the zones of one layer do not overlap any other zones of the same layer.

9. An index according to claim 1, wherein a zone of one layer overlaps one or more zones of another layer.

10. An index according to claim 1, wherein the associated geographical co-ordinates comprise the longitude and latitude or x,y co-ordinates of at least one geographical location in a subject zone.

11. An index according to claim 1, wherein each zone is a polygonal area.

12. A database incorporating an index according to claim 1.

13. A method of indexing data relating to geographical locations comprising:
providing a plurality of layers of geographical information concerning a geographical area, each layer comprising a division of the geographical area into a plurality of discrete zones, each of which has a zone identifier and associated geographical co-ordinates each of which co-ordinates defines a geographical location; and associating for each layer a geographical location with those zones containing the geographical location such that a geographical hierarchy is provided for each geographical location.

14. A method of utilizing a geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone, the method comprising searching the index for a target geographical location and determining therefrom one or more nearby geographical locations or data concerning the nearby geographical locations.

15. A method of analyzing the content of a body of information with reference to a geographical location index comprising a plurality of layers of geographical information concerning a geographical area, each layer comprising a division of the geographical area into a plurality of discrete zones which each have a zone identifier and associated geographical co-ordinates of one or more geographical locations contained within that zone, to determine whether geographical locations named in the body of information fall into a predetermined set of zones.

16. A method according to claim 15, wherein there are a plurality of bodies of information which are ranked with respect to one another, the method further comprising confirming, lowering or raising the ranking of one of the bodies of information in dependence on an extent to which geographical locations named in the body of information fall into the predetermined set of zones.
